(19) United States
(12) Patent Application Publication
(10) Pub. No.: US 2008/0092642 A1
(43) Pub. Date: Apr. 24, 2008

(54) Apparatus and method for volumetric determination of container contents

(76) Inventors: Roger Lee Grimm, Englewood, CO (US); Daniel Lee Grimm, Highlands Ranch, CO (US); Dean Patrick Grimm, Highlands Ranch, CO (US)

Correspondence Address: PATENT LAW & VENTURE GROUP, 2424 S.E. BRISTOL, SUITE 300, NEWPORT BEACH, CA, 92660, US

(21) Appl. No.: 11/586,024

(22) Filed: Oct. 24, 2006

(51) Int. Cl. G01F 17/00

(52) U.S. Cl. 73/149

(57) ABSTRACT

A vessel is supported on a platform having a fulcrum upon which the platform is rested. A base supports the fulcrum and a first fixture; A second fixture is engaged with the vessel or with the platform. A measuring instrument is engaged between the first and second fixtures when the vessel is resting on the fulcrum. The fulcrum is placed off-center so that an unbalanced weight of the vessel and its liquid content applies a measurable force to the instrument. A look-up table defining various amounts of the liquid contained in the vessel relative to their corresponding force measurements enabling the determination of liquid volume in the vessel at any volume of the vessel's contents.

### BACKGROUND OF THE INVENTION

1. Field of the Present Disclosure

This disclosure relates generally to BROAD STATEMENT

2. Description of Related Art Including Information Disclosed Under 37 CFR 1.97 and 1.98

Jones, U.S. Pat. No. 2,132,736, discloses an apparatus for weighing liquids comprising a receptacle adapted to contain a measured volume of liquid, a balance arm rigidly attached to and laterally extending from the receptacle and forming a dipper-like structure, an off-set fixed weight member at the opposite end of the balance arm to form a handle for the dipper-like structure, means to substantially close the receptacle and to exactly define the measured volume of contained liquid, a fixed pivot means on the balance arm intermediate the receptacle and the off-set weight member, means to support the structure upon the fixed pivot means and adjustable weight means on the arm to balance the dipper-like structure upon the pivot support when the receptacle contains the measured volume of liquid and a pointer on the supporting means cooperating with a scale on the balance arm to indicate a balance of the structure upon the pivot support.

McLarrin, U.S. Pat. No. 3,885,639, discloses a beam scales for directly measuring a volume of material which is equal to the volume of an object having a specific gravity different from that of the material. The beam is provided at one end with a support for the object and at the other end with a support for the material and the supports are spaced from the fulcrum for the beam by distances inversely proportional to the specific gravity of the material and object, respectively. Adjustment to accommodate for the measurement of materials having different specific gravities is achieved through the provision of an adjustable fulcrum point or the provision of adjustable suspension points for the supports.

Cain, U.S. Pat. No. 4,321,829, discloses a density measuring apparatus that includes a container for holding a fluid to be tested, a balance arm having a first end attached to the container, a fulcrum for supporting the balance arm, and a balance weight slideably disposed on the balance arm. The balance arm has an inverted channel shape cross-section defined by a top portion and first and second side portions depending downwardly from the top portion. First and second tabs extend downwardly from the first and second side portions and have first and second downward opening recesses disposed therein, respectively. A knife edge of the fulcrum engages the recesses of the tabs so that the balance arm is supported thereby. Approximately one-third of the length of the balance arm adjacent the container includes a longitudinally extending rib member located intermediate of the first and second side portions and depending downward from the top portion of the balance arm. A tab of the rib member extends downward therefrom and engages a notch in the knife edge of the fulcrum.

Cain, U.S. Pat. No. 4,374,474, discloses a fluid density measuring apparatus for measuring the density of a fluid in a pressurized state. The apparatus includes a balance arm, a fulcrum for supporting the balance arm, a balance weight slideably disposed on the balance arm, and a pressurizable container disposed on the balance arm for holding a fluid sample. A valve is connected to the pressurizable container for allowing pressurized fluid to flow into the container and for retaining the fluid in the container under pressure. A pump is provided for supplying pressurized fluid to the valve. The pump includes a pump body having a cylindrical bore disposed therein and an outlet port for communicating the bore with the valve. The pump also includes a rotatable piston member, threadedly engaged with the pump body, for pressurizing fluid contained in the bore of the pump body upon rotation of the piston member relative to the pump body. One alternative embodiment is suitable for both pressurized and non-pressurized fluid density measurements. A second alternative embodiment incorporates the pump in a threaded cover for the container, thereby eliminating the valve member.

Akegi, U.S. Pat. No. 4,708,016, discloses a method for measuring the volume of a sample that comprises measuring the weight of the sample by means of a balance within a sealed vessel containing a first gas; then replacing the first gas in the vessel with a second gas having a density different from that of the first gas; and then measuring the weight of the sample by means of the balance within the sealed vessel containing the second gas to determine a change of weight of the sample corresponding to the change of the gas in the sealed vessel. Then the volume of the sample is calculated according to Archimedis' principle as a function of the value of the difference between the density of the first gas and the second gas, and the value of the change of weight of the sample corresponding to the change of the gas. An apparatus for measuring the volume of the sample is also disclosed.

Hirota et al., U.S. Pat. No. 4,766,964, discloses an apparent density measuring device for a weighing machine comprising a bucket having a known loading volume. Product is fed to the bucket in an amount sufficient to cause overflow from the bucket, the bucket being vibrated for a specific time during this feeding operation. After completion of the feeding operation, the loaded bucket is weighed.

Batchelder, U.S. Pat. No. 5,052,405, discloses a method and apparatus for measuring the volume and density of an object, including a living being, which avoids the necessity of immersing the subject in a liquid medium. Where the subject is a living being, the percentage of body fat may readily be determined from the density value. The density of the subject is measured by recording the weight of the subject for several different temperatures of a fluid, preferably air, surrounding the subject. The apparent weight change of the subject at the different measured temperatures of surrounding air represents changes in the buoyant forces exerted by the air on the subject at different air densities. The buoyant force acting on the subject is calculated from these measurements, and the volume of the subject is determined from its relationship with the buoyant force. The density of the subject can then be calculated from the volume and weight parameters. Where the subject is a human being or animal, its density is monotonically related to its fat content.

Ostermann, U.S. Pat. No. 6,521,847, discloses a scale for weighing moving loads. The scale includes a weighing platform having entrance and exit ends. The platform is connected to a tipping member mounted to pivot about a fulcrum. A weighing device is operatively connected to the fulcrum. Downward movement of the platform entrance end causes the tipping member to pivot in a first direction and downward movement of the platform exit end causes the tipping member to pivot in a second direction. First and second stops limit movement of the tipping member in the first and second directions, respectively. As a load enters the platform, the tipping member pivots against the first stop such that the weight is distributed between the fulcrum and the stop. As the load approaches the center of the platform, the tipping member pivots off of the first stop such that the weight is measurable by the weighing device.

Tibbott, U.S. Pat. No. 6,644,344, discloses a method and apparatus for measuring the flow rate of a fluid based on the fluid weight. A container is provided between a fluid source and a fluid removal system. A valve is arranged between the fluid source and the container, to control the admitting of fluid into the container from the source, and removal of fluid from the container by the removal system. The valve is controlled by a weight-responsive mechanism, which detects a change in weight of the container due to the admitting and removal of fluid, and opens or closes the valve accordingly. A flow rate of the fluid may be determined in terms of a time period between the closing and subsequent opening of the valve.

Ostermann, U.S. Pat. No. 6,838,625, discloses a scale for weighing moving loads that includes a weighing platform having an entrance end and an exit end. The platform is pivotal about a transverse axis between the entrance end and exit end. A first limit stop is engagable to limit downward movement of the entrance end and a second limit stop is engagable to limit downward movement of the exit end. A weighing device is connected to the platform and is operable to provide an indication of the weight of a load supported on the platform when neither the first limit stop nor the second limit stop is engaged.

Lenton, GB2192999, discloses a weighing device, particularly for use as a ullage gauge, that comprises an element for engaging and tilting an article to be weighted, flexible arm secured to the element with a handle at its end remote from the element for tilting the article, causing deflection of the arm, and a rigid pointer for enabling the deflection of the arm to be measured against scale means. The element may engage a projection or feature of the article or be inserted under it. The scale means may include lost motion for eliminating tare weight of the article. Adaptors may be provided for enabling the device to be used for different articles such as bulk storage containers.

The related art described above discloses several methods for determining volume and weight of liquids. However, the prior art fails to disclose a simplified, quick and accurate method for measuring the volume of a liquid in a vessel of any shape. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

A vessel is supported on a platform having a fulcrum upon which the vessel is rested on a base. A force measuring instrument is engaged between the base and the vessel or its platform. The fulcrum is placed off-center so that an unbalanced weight of the vessel and its liquid content applies a measurable force to the instrument. A lookup table defining various amounts of the liquid contained in the vessel relative to the force measurements enables the determination of liquid volume in the vessel at any level of volume and independent of the shape of the vessel.

A primary objective inherent in the above described apparatus and method of use is to provide advantages not taught by the prior art.

Another objective is to enable the determination of a volume of liquid stored within a container or vessel of indiscriminate shape.

A further objective is to enable such a determination of volume by a simple weight measuring method.

A still further objective is to enable such a measurement with repeatable accuracy and at any level of precision desired.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a mechanical schematic showing a vessel holding a volume of a liquid, tilted to one side on a fulcrum and resting on a base.

FIG. 2 is a mechanical schematic showing the vessel as resting on the fulcrum with a force measuring device attached between base and vessel.

FIG. 3 is a mechanical schematic showing the vessel as mounted on a platform which, in turn, is resting on the fulcrum with the force measuring device attached between base and platform;

FIG. 4 is a perspective view of the vessel as mounted on the platform with a measuring arrangement capable of receiving a tensile load;

FIG. 5 is a perspective view of the platform resting on the base; and

FIG. 6 is similar to FIG. 4 showing a rigid measuring strut capable of receiving a compressive load.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

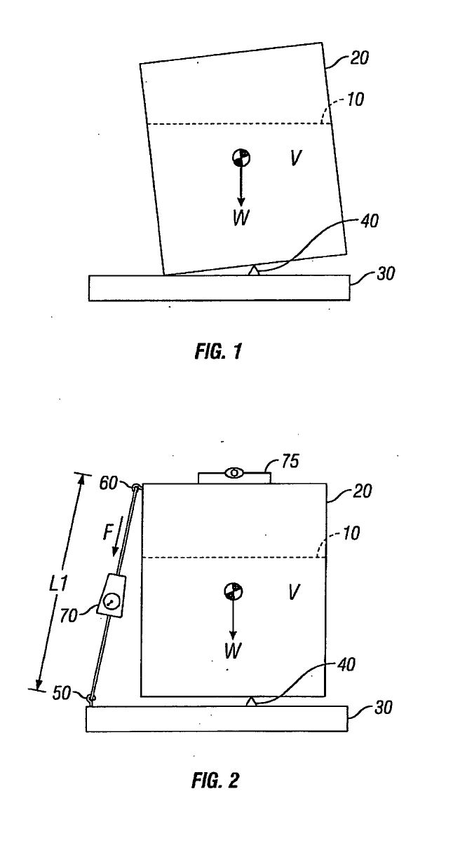

Described now in detail is an apparatus for determining the volume of a liquid 10 in a vessel 20. The present concept is presented in FIGS. 1-3 in schematic form. In FIG. 1 the vessel 20 rests on a fulcrum 40 which is supported by base 30. One may imagine the vessel 20 as being a round barrel as shown in FIG. 4, however, the vessel 20 may be almost any shape so that the present apparatus and method, are able to measure the volume of liquid 10 in a container of irregular shape. In FIG. 2 the vessel rests only on offset fulcrum 40 and held in place by measuring instrument 70 so that its unbalanced weight may be determined as will be described below.

Fulcrum 40 is assumed to be a linear bar extending into the drawing sheet, so that the vessel b is restricted to move on the fulcrum only within the plane of the drawing sheet. In FIG. 1, the weight vector W of vessel 20 plus liquid 10 is shown extending vertically down to the left of fulcrum 40 so that the vessel 20 rests in static equilibrium against base 30. In FIG. 2, the fulcrum 40 is placed offset to the right so that, again, the vessel 20 naturally tilts to the left. In this figure, vessel 20 has been moved to an upright position supported by fulcrum 40, and a force measuring instrument 70 has been placed between vessel 20 and base 30 so that the unbalanced force F of vessel 20 and liquid 10 is measured. In FIG. 2, vessel 20 has been placed in an upright level attitude according to bubble level 75. In this approach, we replicate the exact position of vessel 20 during each measurement of force F and therefore the only independent variable is the volume V of liquid 10, which is determinable since it corresponds to force F on a one-to-one basis. Of course, bubble level 75 is not necessary and vessel 20 need not be placed with its top horizontal. Actually, with vessel 20, in any attitude that will produce force F is suitable. In this approach, instrument 70 and its connecting fixtures are rigid, incompressible members able to receive the compressive force F without a reduction in their length L1. Instrument 70 contains a load cell or similar type force measuring device so that force F is measured without a corresponding change in L1. Since mechanical fixtures may have, or may develop some play in them over time and with use and wear, preferably a length adjustment device, such as a turnbuckle may be employed to assure that the instrument 70 and its fixtures is always at length L1. To summarize then, as long as length L1 is a constant, measurements of F can be taken as the volume V changes, with the assurance that V is a linear function of F.

Since force F is a function of the unbalanced volume of liquid 10 in vessel 20, by adding known increments of liquid 10 to vessel 20, and for each of the increments measuring force F, a look-up table of force F verses volume V, is produced, where V is the total volume of liquid in vessel 20. Clearly, the shape and weight of vessel 20 need not be known in order to produce this look-up table. As long as the shape of vessel 20 does not change between measurements, and the position of the fulcrum 40 is fixed relative to vessel 20, and the measuring instrument and its attachment fixtures remain at a fixed length L1, the look-up table reliably identifies the volume of liquid 10 in vessel 20.

A typical look-up table for beer stored in kegs may appear as follows:

| Force (pounds) | Volume (pints) |
|---|---|
| 30 | 10 |
| 50 | 20 |
| 70 | 30 |
| 90 | 40 |

Clearly, such a look-up table may be produced with any level of precision desired and units may be liquid ounces, grams, pounds, etc. for force F, and ounces, ml, pints, quarts, liters, etc., for volume V. Since the force F and volume V are linearly related a simple linear graph showing F versus V enables the determination of V for any measured value of F. The look-up table, as defined herein, also refers in general to a look-up means, and such a look-up means may alternately be a chart showing a graph relating the variables F and V, or a computational formula algorithm that is access via a digital computer, or other means for defining values of V corresponding to measured values for F.

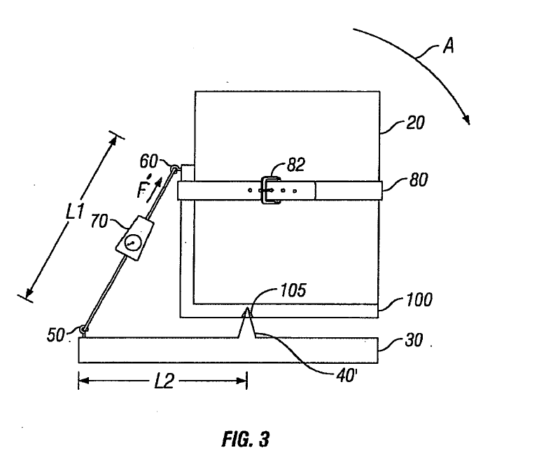

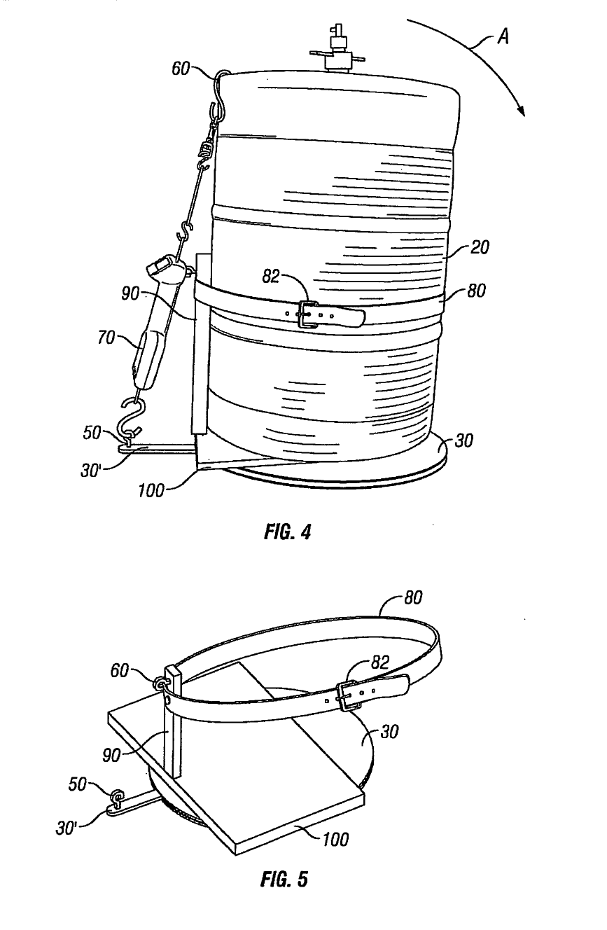

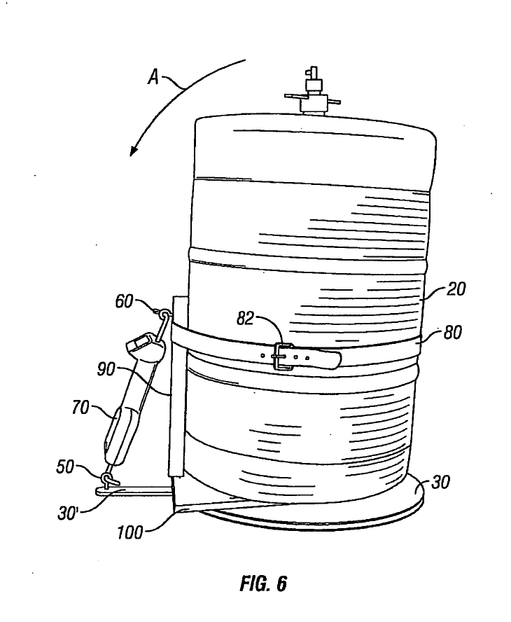

In an alternative embodiment, shown in FIG. 3, fulcrum 40′ may be placed to the left of the weight vector W so that vessel 20 tends to tilt to the right as shown by arrow A, and force F′, a tension, is induced in instrument 70. In this case, as shown in FIG. 3, the instrument 70 and its connecting fixtures need not be able to support a compressive load, but merely a tension load as illustrated in FIG. 4.

Preferably, vessel 20 is mounted fixedly on a platform 100, as shown in FIGS. 3 and 6. Preferably, platform 100 provides a rigid upright post 90 which engages a belt 80 which is extensive for encircling the vessel 20 when the vessel 20 rests on the platform 100. The belt 80 is positioned and enabled by its length and its buckle 82 for drawing the vessel 20 into abutting contact with the post 90, thereby positioning the vessel at a fixed and replicable position relative to fulcrum 40′ and thereby placing the weight vector W to one side or the other of the fulcrum 40′ depending on the position of fixed slot 105 which defines L2, the distance from fulcrum 40′ to fixture 50. Therefore, with L1 and L2 held constant, V is determinable by measuring F.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. An apparatus for determining liquid volume in a vessel, the apparatus comprising: a base providing a linear fulcrum upon which the vessel is rested in an off-center position, and a first fixture; a second fixture adapted for removable engagement with the vessel; a force measuring instrument engaged between the first and second fixtures; and a look-up means defining a liquid volume in the vessel relative to an unbalanced force as measured by the force measuring instrument when the vessel is supported by the force measuring instrument in an unbalanced position on the fulcrum.

2. The apparatus of claim 1 further comprising a platform engaged with the vessel.

3. The apparatus of claim 2 wherein the platform provides an upright post and a belt, the belt extensive for encircling the vessel when the vessel rests on the platform, the belt positioned and enabled for drawing the vessel into abutting contact with the post, thereby positioning the vessel at fixed position.

4. The apparatus of claim 3 wherein the platform provides a means for engaging the platform with the linear fulcrum.

5. An apparatus for determining liquid volume within a vessel of the apparatus, the apparatus comprising: the vessel, a platform upon which the vessel rests; a base supporting the platform on a fulcrum, the base having a first fixture; a second fixture engaged with an upwardly extending post of the platform; a force measuring instrument engaged between the first and second fixtures; and a look-up means defining a liquid volume in the vessel relative to an unbalanced force measured by the force measuring instrument.

6. The apparatus of claim 5 further comprising a belt, the belt extensive for encircling the vessel when the vessel rests on the platform, the belt positioned and enabled for drawing the vessel into abutting contact with the post, thereby positioning the vessel at a fixed position relative to the fulcrum, said position placing a vertical center of symmetry of the vessel to one side of the fulcrum.

7. An apparatus for determining liquid volume, the apparatus comprising: a vessel holding a volume of liquid, a fulcrum upon which the vessel rests at a selected tilted angle; and a means for securing the vessel at the selected tilted angle, the securing means providing a force measuring means enabled for measuring a tilting force exerted on the vessel, and a look-up means defining a liquid volume in the vessel corresponding to a measured tilting force.

8. The apparatus of claim 7 wherein the support platform provides an upright post and a belt, the belt extensive for encircling the vessel when the vessel rests on the platform, the belt positioned and enabled for drawing the vessel into abutting contact with the post, thereby positioning the vessel at a fixed position relative to the fulcrum, said position placing a center of gravity of the vessel to one side of the fulcrum.

9. A method for determining a volume of a liquid in a vessel, the method comprising the steps of: resting the vessel, when empty, on a fulcrum at a fixed tilt angle; reading a force measurements asserted by the vessel for a plurality of known liquid volume contents; producing a look-up means of the force measurements associated with the known liquid contents; and identifying an unknown liquid volume within the vessel by reading a force measurement of the measuring instrument and then reading a corresponding liquid volume on the look-up means.
